(19) United States
(12) Patent Application Publication
(10) Pub. No.: US 2006/0289218 A1
(43) Pub. Date: Dec. 28, 2006

(54) Zoom zoom

(76) Inventor: Robert Allen, Simms, TX (US)

Correspondence Address: Wilson Daniel Swayze, Jr, 3804 Clearwater Ct., Plano, TX, 75025, US

(21) Appl. No.: 11/167,693

(22) Filed: Jun. 27, 2005

(51) Int. Cl. B60K 17/30

(52) U.S. Cl. 180/252

(57) ABSTRACT

A vehicle capable of turning 360° includes a steering apparatus to steer the vehicle, and a wheel to turn the vehicle and to be responsive to the steering apparatus. The wheel turns the vehicle 360° without reversing.

### FIELD OF THE INVENTION

The present invention relates to steerable vehicles and more particularly to vehicles which can change directions quickly.

### BACKGROUND OF THE INVENTION

It is known to provide lawn and garden tractors with four steerable wheels to thereby decrease the tractors minimum turning radius. One such four-wheel steering system is described in U.S. Pat. No. 5,174,595. This patent describes a tractor that has a frame and front and rear pairs of wheels for supporting the frame. The front and rear pairs of wheels are pivoted to the steer the tractor. The front and rear center-pivot members are pivotally connected to the frame at respective points located approximately at the centerline of the tractor. Each front tie rod of a pair of front tie rods extends respectively between the front center-pivot member and the front wheels for pivoting the front wheels as the front center-pivot member pivots. Each rear tie rod of a pair of rear tire rods extends respectively between a rear center-pivot member and the rear wheels for pivoting the real wheels as the rear center-pivot member pivots. A linkage assembly operatively connects the front and rear center-pivot members for transmitting pivotal motion there between.

However, this vehicle can not turn either the front wheels or the rear wheels 360° in order to provide a vehicle that can turn extremely quickly. This conventional vehicle has a stopping point for the steering mechanism such that it is impossible to turn the front or rear wheels beyond the stopping point. This introduces a severe limitation on the turning radius of the vehicle.

### SUMMARY OF THE INVENTION

The present invention is an all directional 360° turning vehicle which may have power applied to all wheels or a portion of the wheels. The present invention is capable of going in any direction substantially instantly; sideways, backwards, which may eliminate a reverse transmission. The direction of the rear wheels may be independently controlled or controlled in tandem with the front wheels. The present invention can be driven while seated or standing.

### BRIEF DESCRIPTION OF DRAWINGS

FIG. 1 illustrates a side view of the vehicle of the present invention;

FIG. 2 illustrates a side view showing the power train of the vehicle;

FIG. 3 illustrates a front view of the vehicle of the present invention;

FIG. 4 illustrates a side view of the steering mechanism of the present invention;

FIG. 5 illustrates a detailed side view of the present invention;

FIG. 6 illustrates a front view of a wheel and the power train to that wheel of the present invention;

FIG. 7 illustrates a perspective view of another embodiment of the present invention;

FIG. 8 illustrates a side view of the vehicle of the present invention with three wheel steering;

FIG. 9 illustrates an embodiment of the present invention with aircraft;

FIG. 10 illustrates a vehicle of the present invention with four wheels;

FIG. 11 illustrates a side view of a four wheeled vehicle;

FIG. 12 illustrates a side view of a motorcycle using the principles of the present invention;

FIG. 13 illustrates a top view of the power train for the electric motor;

FIG. 14 illustrates an the three wheel fork system with gears;

FIG. 15 illustrates the steering system of the present invention;

FIG. 16 illustrates the fork and gears of the present invention

FIG. 17 illustrates the present invention applied to a trolley.

FIG. 18 illustrates another embodiment of the present invention

FIG. 19 illustrates another embodiment of the present invention.

### DETAILED DESCRIPTION

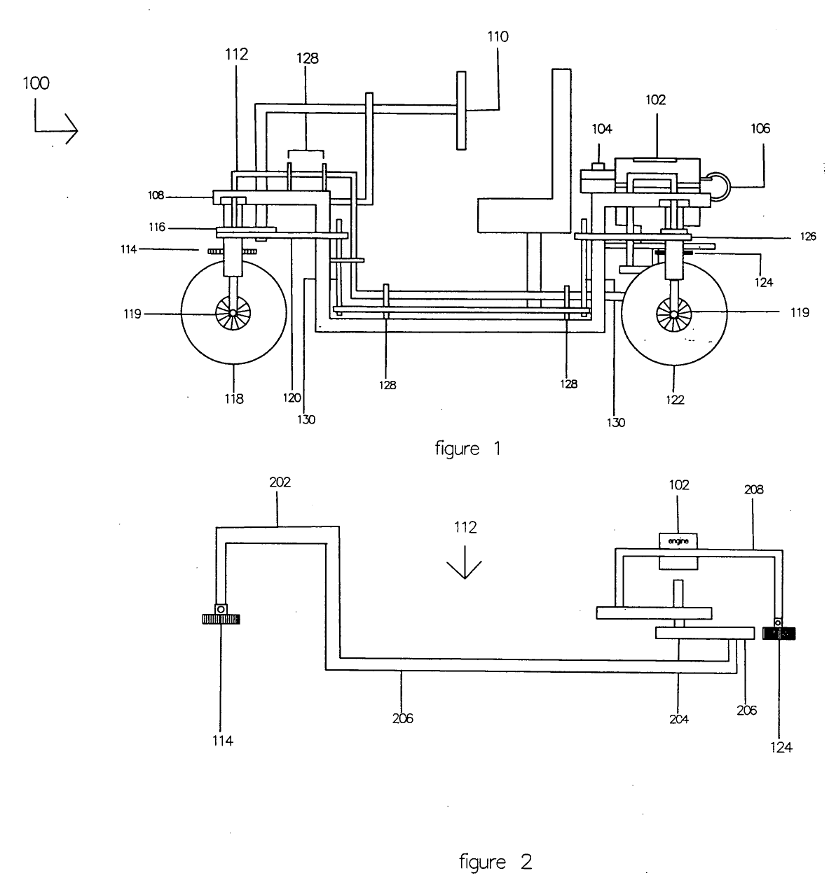

FIG. 1 illustrates a four-wheel drive and four-wheel 360° steering vehicle 100. The vehicle 100 can turn the wheels 360° without reversing the direction of the wheels. A vehicle 100 includes as illustrated in FIG. 1 an engine 102 to drive all of the wheels of the vehicle 100 and a gas tank 104 which contains fuel for the engine 102. Spark and spark wire 106 are used to ignite gasoline in the engine 102. Additionally, the vehicle 100 includes a frame 108 to provide support for the vehicle 100. The vehicle 100 is steered by the steering wheel 110, and the steering wheel 110 turns all four of the wheels at the same time 360° without reversing the steering wheel or the vehicle wheels. The vehicle additionally includes shaft 112 which in this example is 90° shaft which allows the shaft to be bent up to 90° to follow the frame and to transmit the power from the engine 102 to all four wheels simultaneously. Additionally, shown in FIG. 1 is a gear 114 to apply the power to the wheels 118 and wheels 122. Timing belt 120 is used to connect the shaft from the steering wheel to stack pulley 116 thus, allowing the steering wheel 110 to turn the wheels 118 at the same time as the rear wheels 122. The motor 102 powers gears 124 and the timing belt 120 perform a similar function as gear 114. The rear wheels 122 are turned by pulley 126 which is connected to the shaft 130 to allow the steering wheel 110 to turn the front wheels 118 as well as the rear wheels 122.

The vehicle 100 includes a bearing holder 128 to hold a shaft 112 at a predetermined distance from the frame 108. As the user of the vehicle 100 turns the steering wheel 110, the shaft from the steering wheel 110 turns the timing belt 120 which turns the stack pulley 116 which turns the front wheels 118. Additionally, the timing belt 120 turns the shaft 130 which turns the belt 126 so that the rear wheels 122 turn in the same direction and for the same angle as front wheels 118.

Turning now to FIG. 2, the shaft 112 is shown in detail without the associated bearing holder 128. The shaft 112 includes shaft 202 to transmit the engine power from the engine 102 to the front wheels 118. As shown in FIG. 2, a double stack pulley 204 is used to transmit the power of the engine 102 to the shaft 202 which transmits the power to the front wheels 118 and the shaft 208 which transmits the power from the engine 102 to the rear wheels 122.

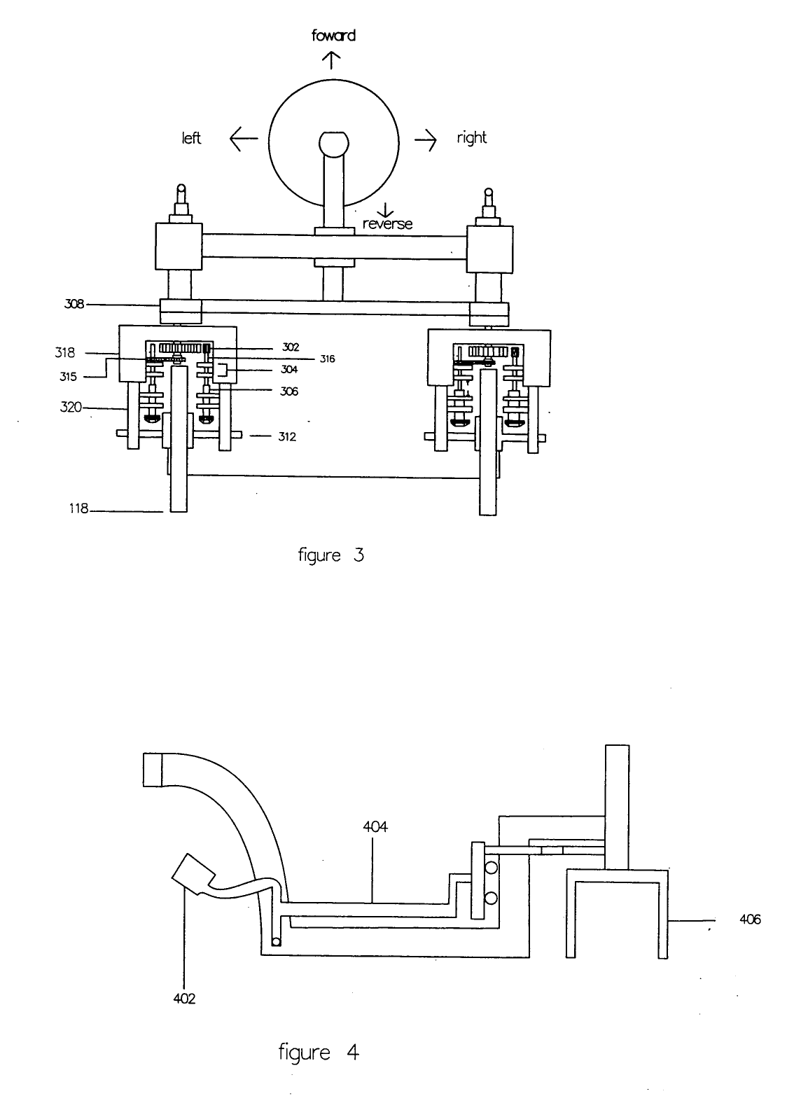

FIG. 3 illustrates additional details of the wheel for example the front wheel 118 or the rear wheel 122. FIG. 3 shows a gear 302 being connected to the shaft 316 so that power can be transmitted to the wheel 118. The larger gear 314 is connected to shaft 112 which in turn is connected to gear 302. The gear 302 turns the shaft 316 which is held in place by bearing holder 304. The shaft 316 is connected to a slidable shaft 306 so that any vertical motion of the vehicle does not interrupt the power to the wheel 118. The bearing holder 304 is connected to fork 318 which in turn is connected to shock absorber 320 which is connected to shaft 312 for mounting the wheel 118. FIG. 3 additionally shows a steering belt 308 to turn the wheel 118.

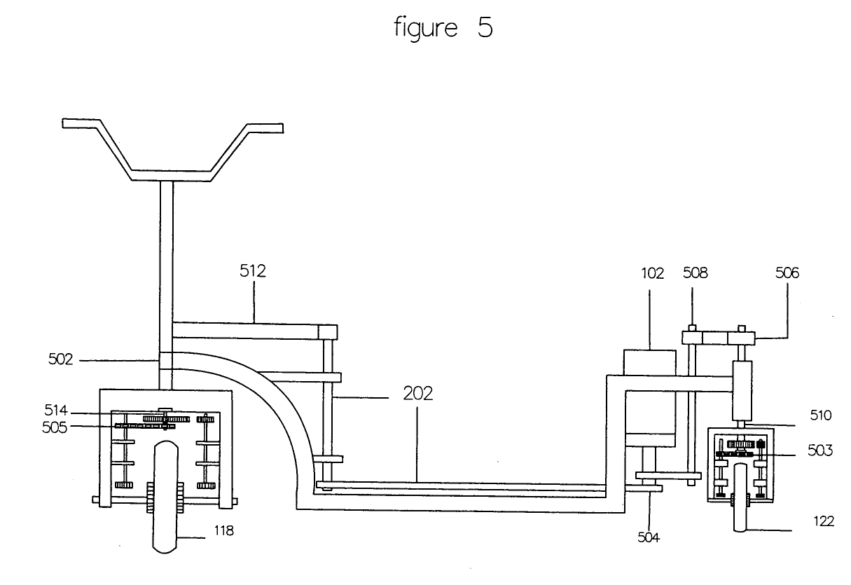

FIG. 4 illustrates a steering system of the present invention. The element 402 illustrates a foot pedal to turn the rear wheels 122 (not shown) independently of the front wheel 118. A shaft 404 connects the foot pedal 402 with the rear fork 406.

FIG. 5 illustrates details for supplying power to the front and rear wheels. Double stack pulley 504 is connected to motor 102 to transfer power from the motor to the belt or shaft 202. The power from the engine 102 is applied to the front wheels 118 by a belt or shaft 202. Additionally, the power to the rear wheels 122 is transferred through the belt 506 and is obtained through the use of the double stack pulley 504. The double stack pully 504 is connected through a belt to shaft 508. Belt 506 is connected to shaft 510 which powers the rear wheels 122. Additionally, FIG. 5 shows head stack 502 coupled to belt 512 and to shaft 514 to drive the front wheels 118.

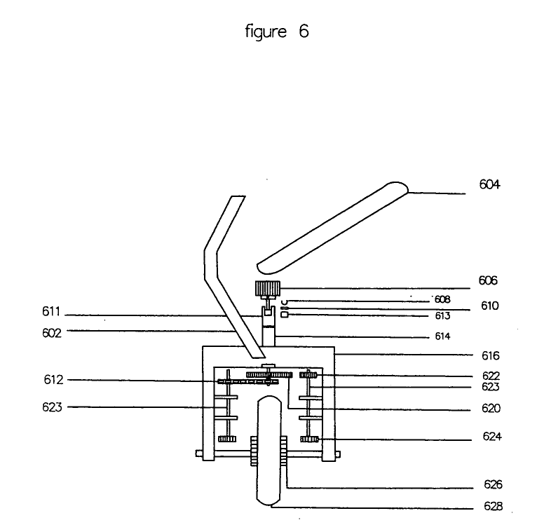

FIG. 6 illustrates the details of one of either the front wheels 118 or the rear wheels 121. The handlebar 602 is used to steer the vehicle, and belt 604 is used to drive the timing pulley 606. The timing pulley 606 drives a shaft which goes through the center of the pulley 606 and is supported with bearings 613. Element 608 is an E-clip and, element 610 is a washer. Element 611 is a bearing holder to hold bearings which is shown as element 613. The headstock 614 includes bearing for the shaft and the forks 616 are used to hold the axle for the wheel 628. The forks 616 include bearings for the shaft 608 which is connected to the spur gears 622 and to turn the spur gears 622. Each of the spur gears 622 is connected shaft 623 and is connected to the helical gear 624 which drives the helical gear 626 mounted on the wheel 628.

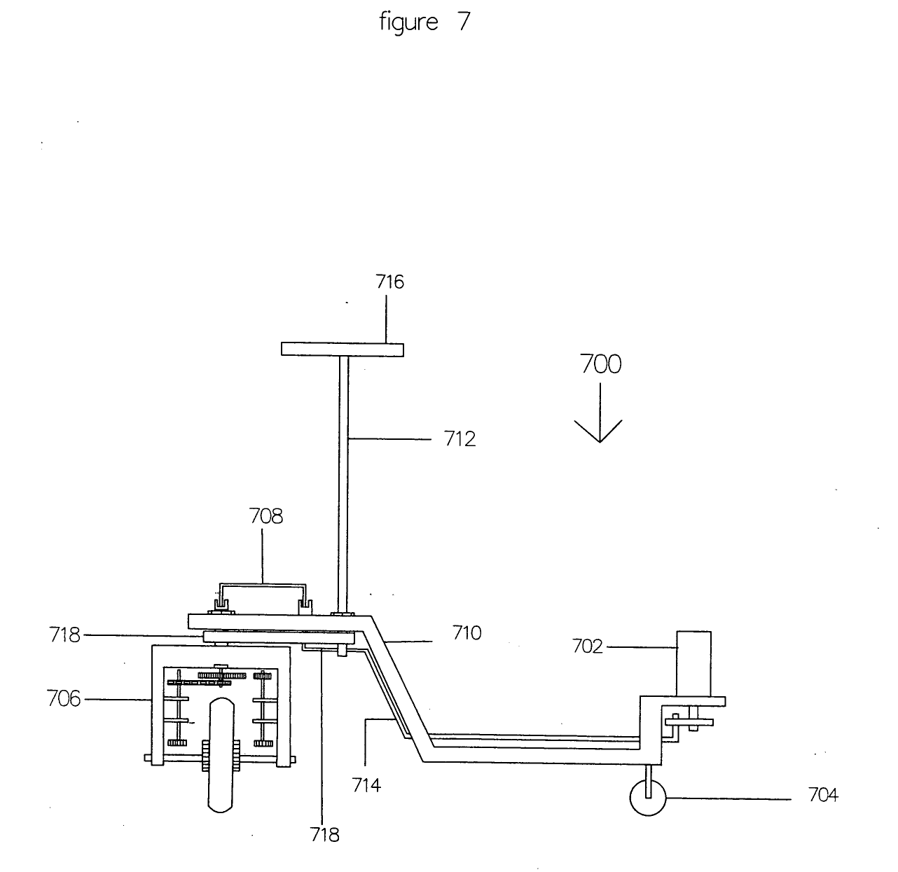

FIG. 7 illustrates an additional embodiment of a vehicle using castor wheels. In FIG. 7, the electric motor 702 is used to power the vehicle 700. Castor wheels 704 are used as rear wheels, and the front wheels could be castor wheels additionally. The front wheels include a front fork 706 which turns 360° to provide flexibility in steering the vehicle 700. Also shown in FIG. 7 is shaft 708 which may bend at 90° to supply power from the engine 702. The shaft 708 is mounted along the frame 710 of the vehicle 700. The vehicle 700 includes a steering pulley 718 to connect with steering shaft 712 and is connected to a T-shaped handle 716. As the T-shaped handle 716 is turned, the steering shaft 712 turns the steering pulley 718 to turn the wheel; the wheel turns completely around 360° without reversing direction.

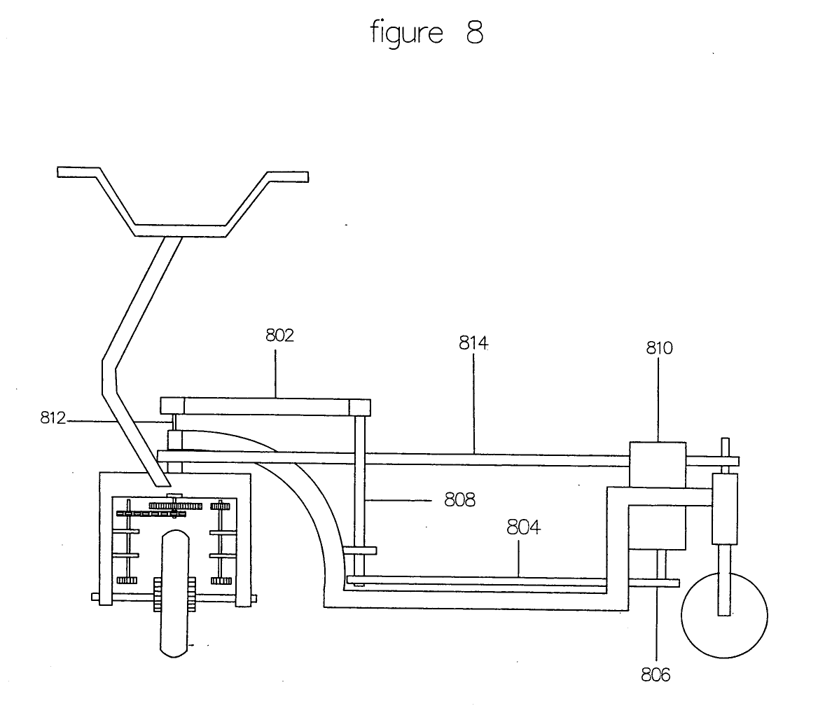

FIG. 8 illustrates an all wheel drive vehicle. As illustrated in FIG. 8, the belt 814 is connected to three wheels which include wheel 118 and wheels 121 to provide and coordinate steering of all three wheels 118 and 121. To distribute the power from the engine 810, a belt 804 connects pulleys which are connected to the engine and shaft 808. The shaft 808 and the shaft 812 are connected by belt 802 to transfer power from the engine 810 to the front wheel.

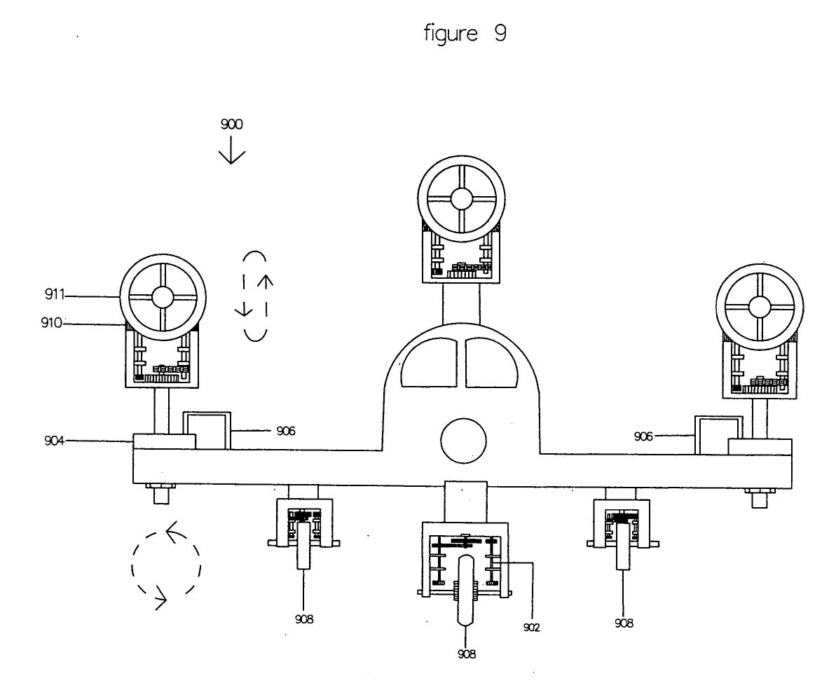

FIG. 9 illustrates a military jet design using the teachings of the present invention. The jet plane 900 is shown having three wheels 908 which can turn 360° without reversing direction based on the teachings of the present invention and three engines 911. Additionally, the jet engine 911 includes gears 910 to turn the jet engine 911 up and down 360° without reversing direction. In addition, the jet engine 911 includes gear 904 to turn the jet engines 91 1 left and right 360° without reversing direction. As a consequence of the above description and drawings, the jet 900 can take off, go straight up execute a 360° turn; all on land or in the air.

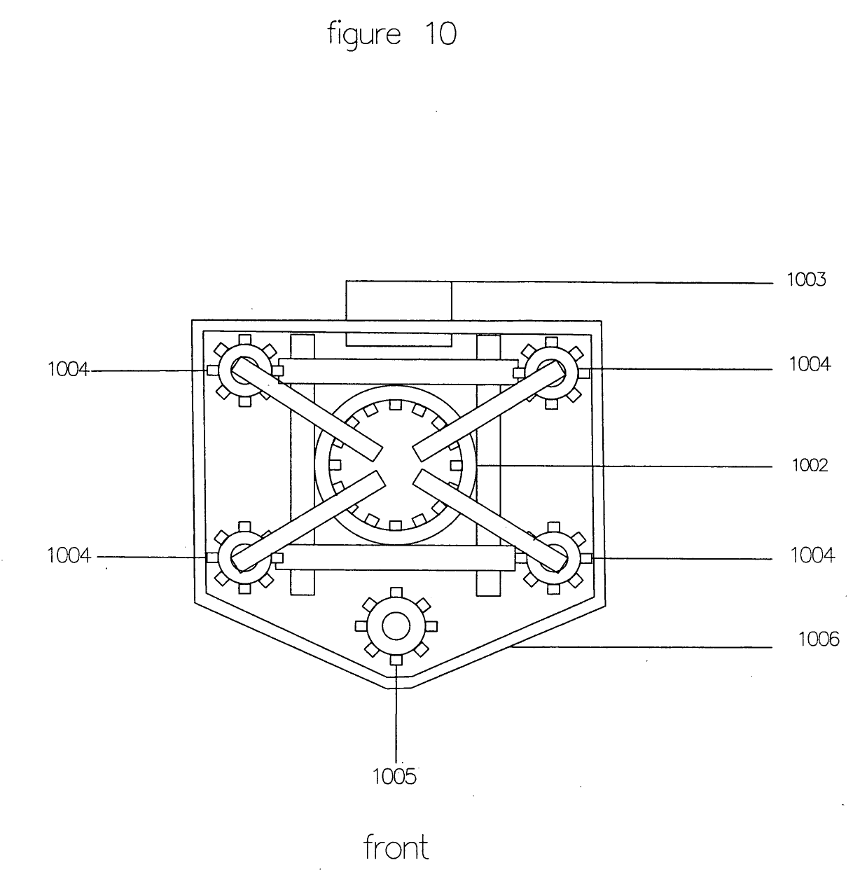

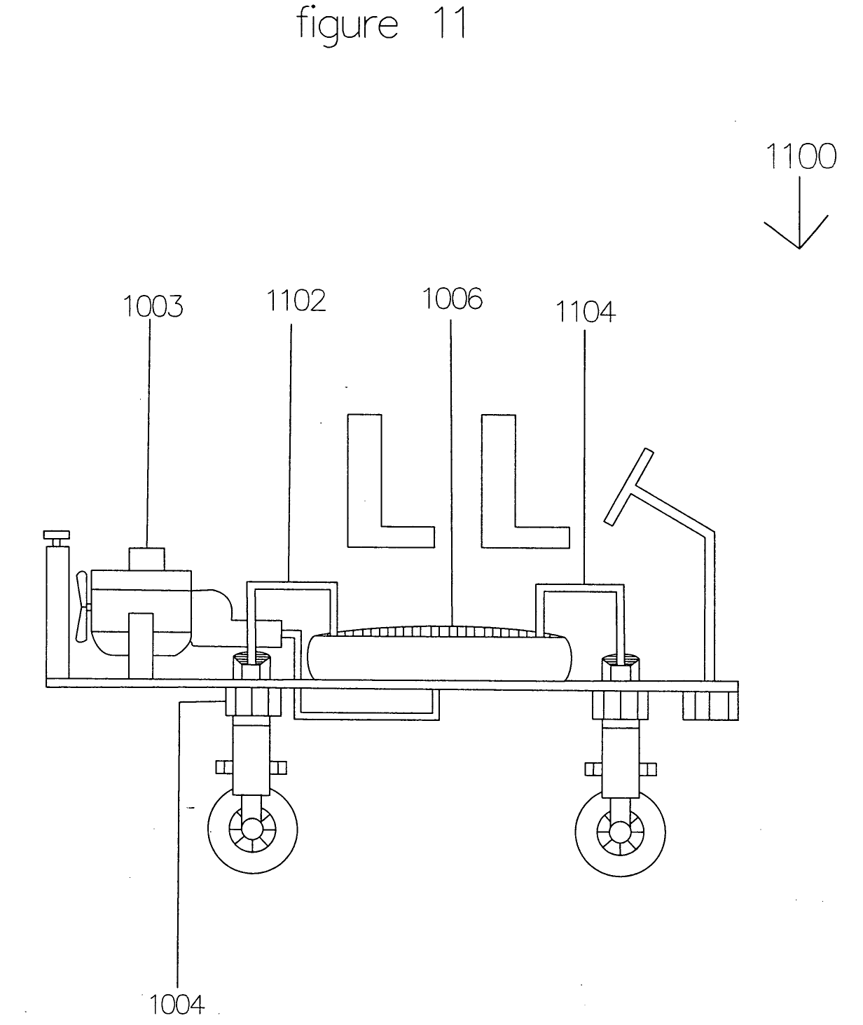

FIG. 10 shows the gear system to distribute power to all four wheels. The engine 1003 distributes power to the large gear 1002, and the large gear 1002 distributes power to all four wheels. The belt 1006 turns a gear or pulley 1004 for each wheel.

In FIG. 11, a four-wheel vehicle 1 100 that employs the gear system of FIG. 10 is shown as having the gear 1006 which is connected to shaft 1104 and shaft 1102 which drive front and rear wheels respectively. FIG. 11 additionally illustrates the engine 1003 which drives gear 1006.

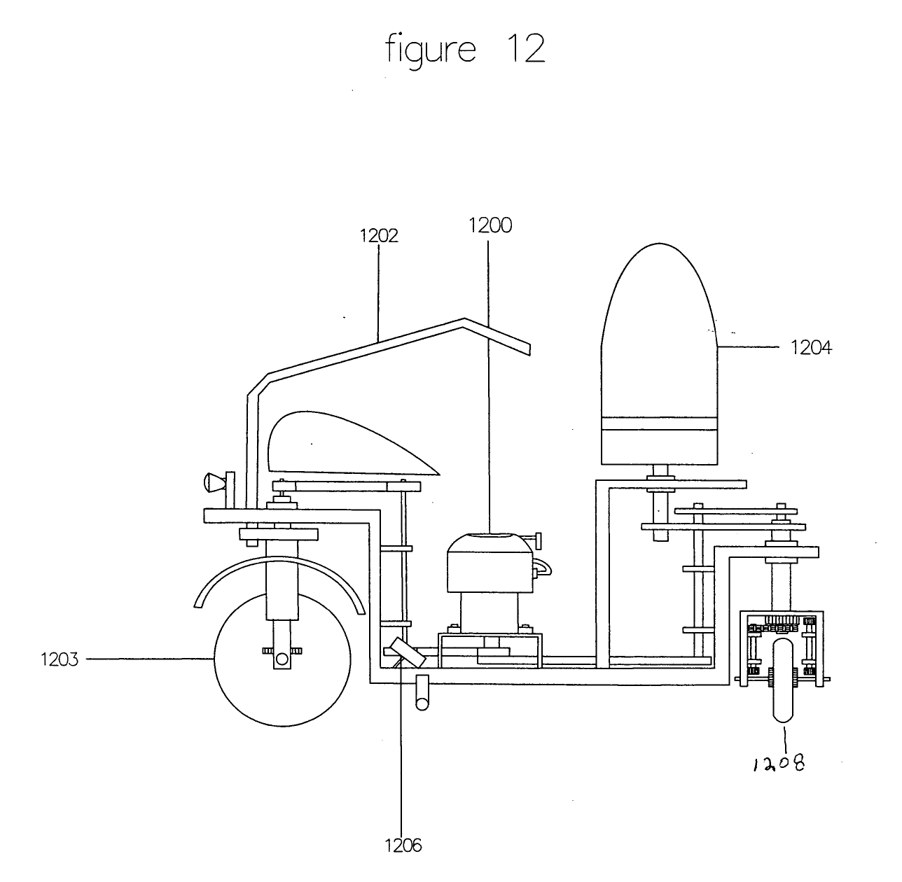

FIG. 12 shows a motorcycle using the principles of the present invention. The engine of the motorcycle 1200 powers both the front and rear wheels, and the front and rear wheels are steerable. The handle 1202 steers the front wheel 1203 360° without reversing direction while the seat 1204 steers the back wheel 1208 360° without reversing direction. Alternatively, foot pedals 1206 may turn the back wheel 1208.

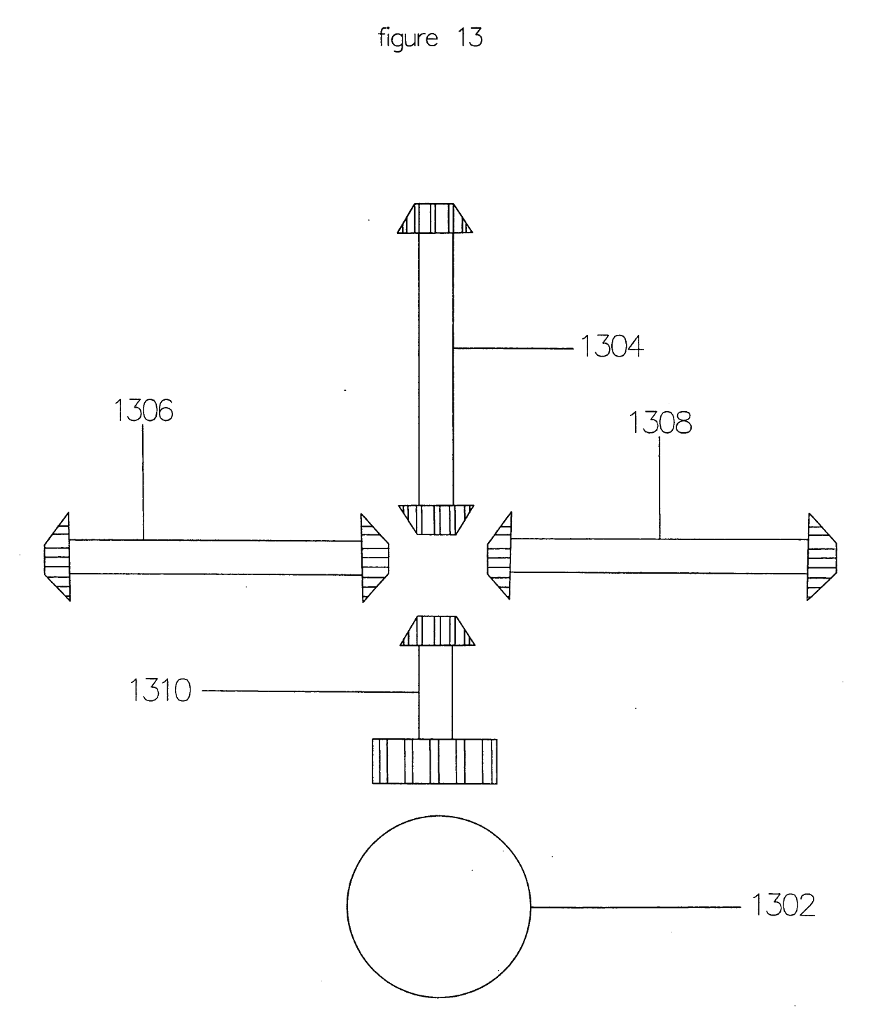

FIG. 13 illustrates a power distribution system including various shafts to power each wheel of a three-wheel vehicle. FIG. 13 shows an electric motor 1302 to power the various shafts which power each wheel of the three-wheel vehicle. The electric motor 1302 powers a common shaft 1310 which in turn powers the shaft 1304 for the front wheel, the shaft 1306 powers the left wheel 1306 and the shaft 1308 powers the right wheel.

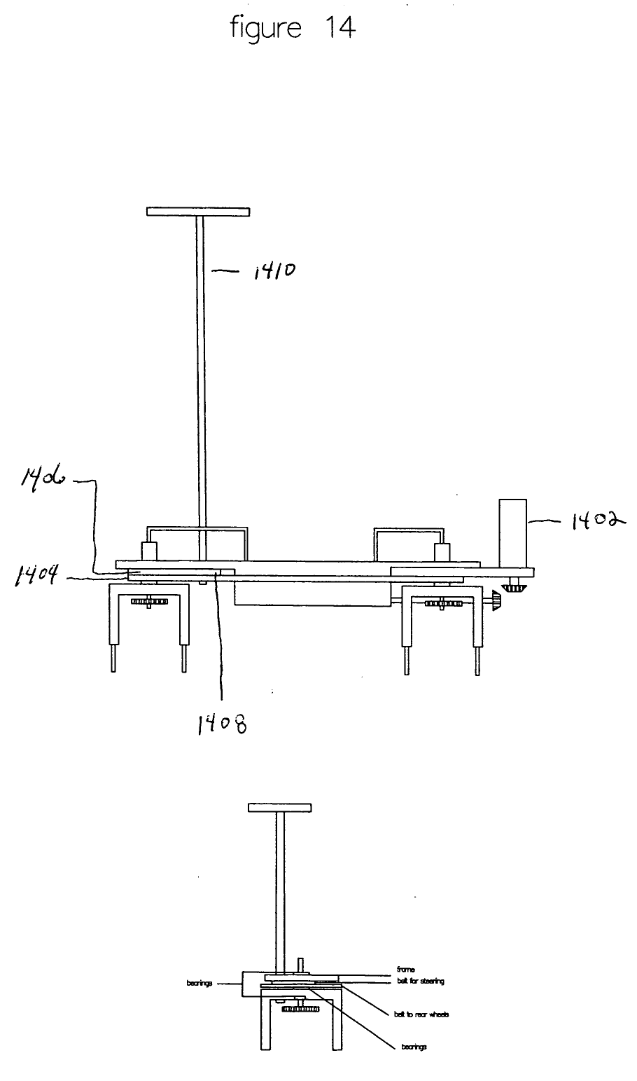

FIG. 14 illustrates a steering system for the present invention. In FIG. 14, a T-shaped handle 1410 steers the vehicle by turning gear 1408 which turns gear 1404. The shaft connected to gear 1404 is connected to pulley 1406 which turns a belt which is connected to either three or four wheels for steering.

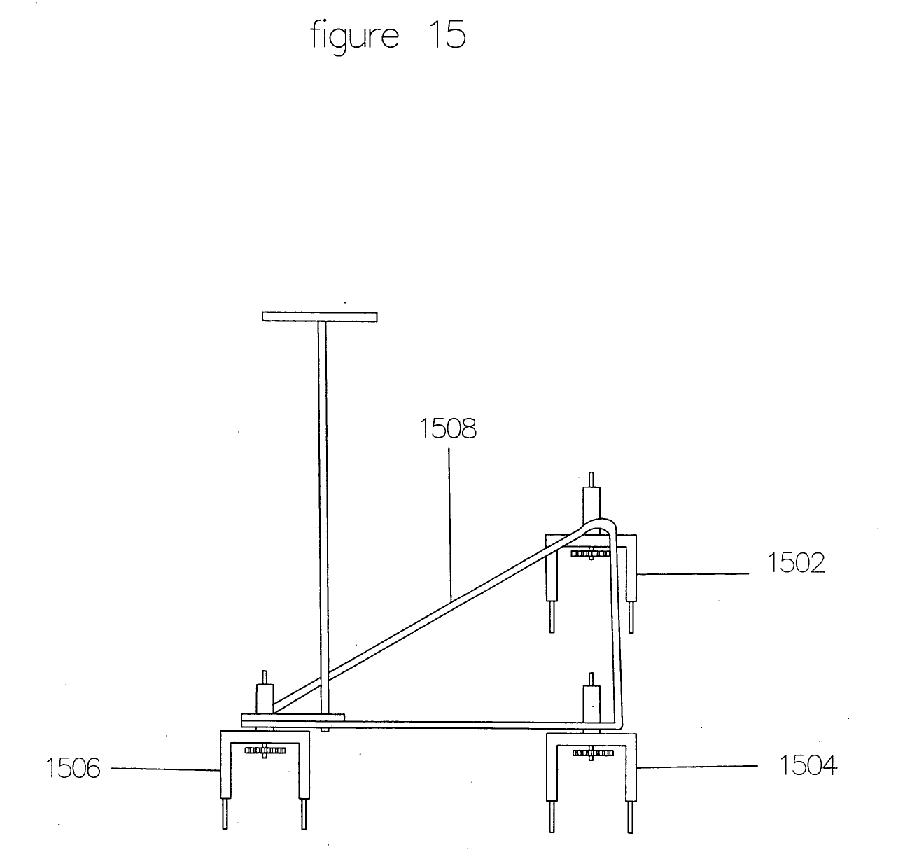

Turning now to FIG. 15, FIG. 15 shows a belt 1508 to go around the forks in order to simultaneously turn all of the wheels of the vehicle.

Although, the present invention has been described in terms of a belt to turn all the wheels of the vehicle, a chain, or hydraulics could be used in place of the belt.

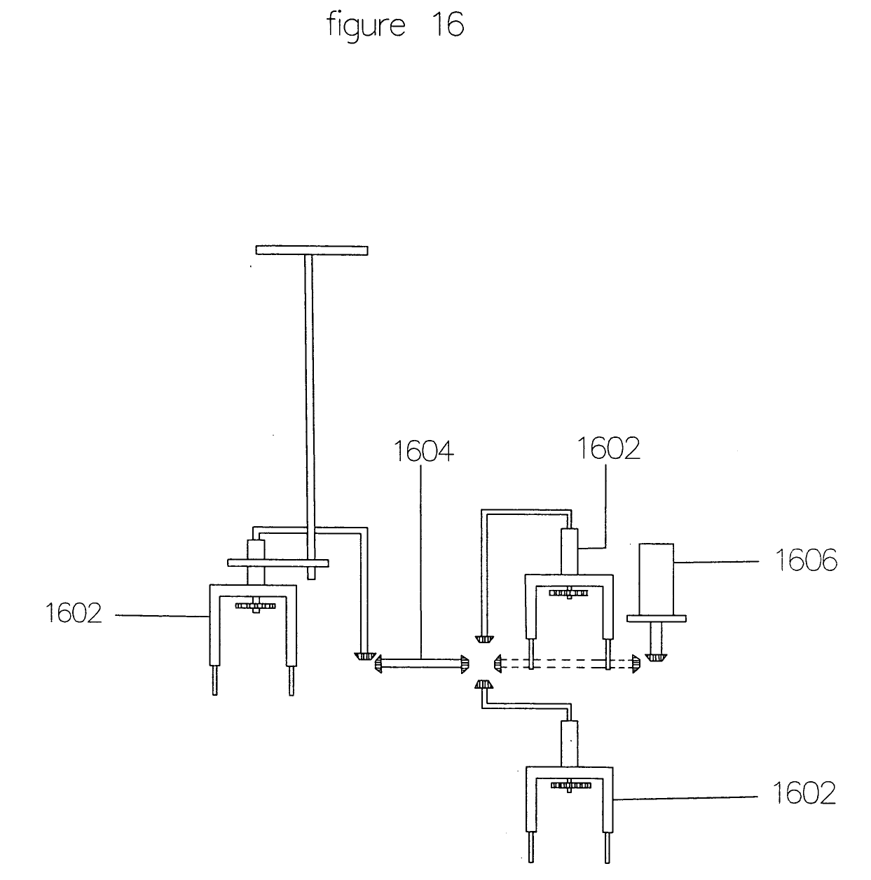

FIG. 16 illustrates the use of forks 1602 in conjunction with gears and shaft 1604 connected to motor 1606 in order to power the vehicle.

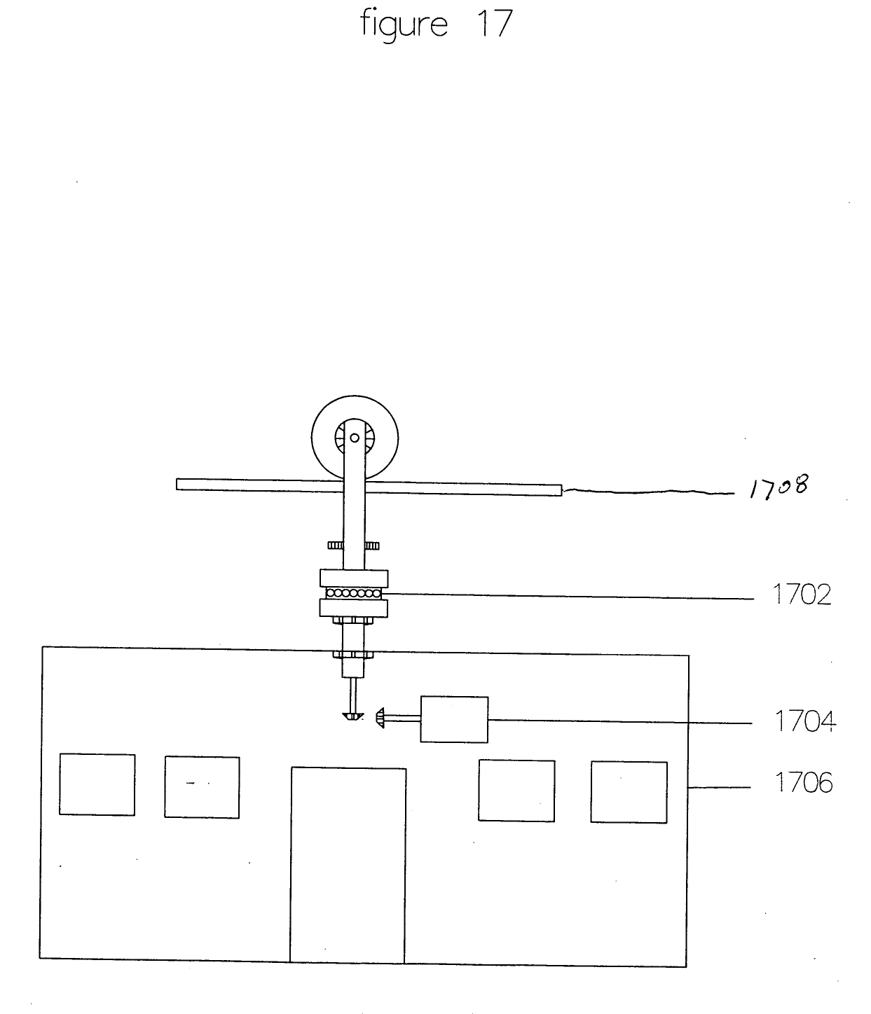

FIG. 17 illustrates a trolley system incorporating the teachings of the present invention. The trolley car 1706 moves along a cable 1708 with bearings 1702 and a motor 1704 to turn the trolley car 1706 360° without reversing direction.

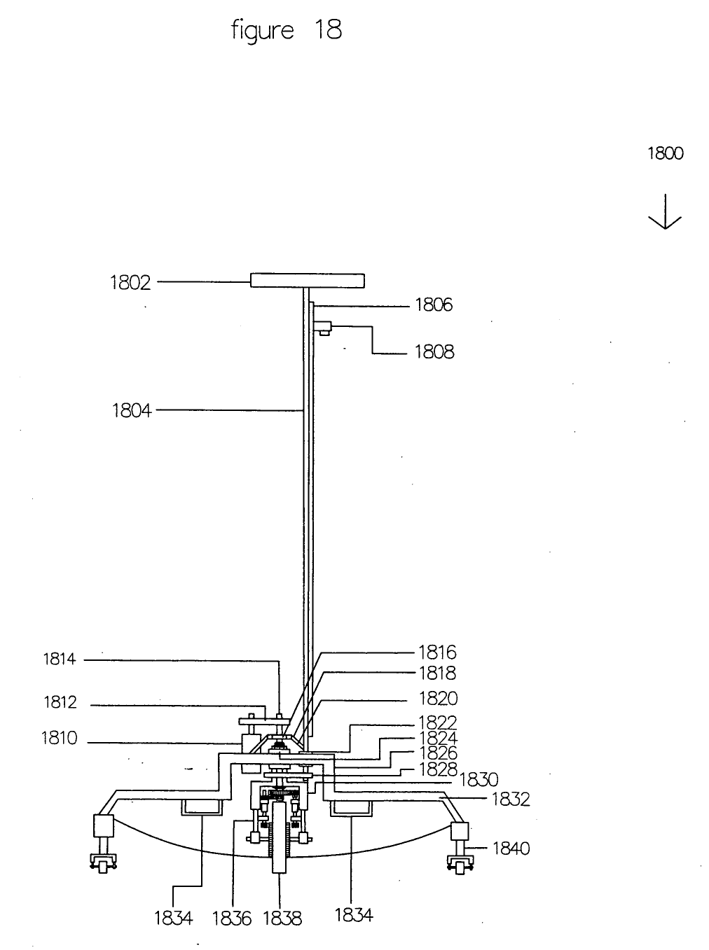

FIG. 18 illustrates another embodiment of the present invention. Steering wheel 1802 is used to steer the vehicle 1800 of FIG. 18. The steering wheel 1802 is connected to a shaft 1804. A throttle wire 1806 runs along the shaft 1804 and is connected to an electric thumb throttle 1808 to control the speed of the motor 1810. The throttle wire 1806 is connected to electric motor 1810 to drive the vehicle 1800. The motor 1810 is connected to a belt 1812 to drive shaft 1814 which is connected to bearings 1816. The bearings 1816 are located in bearing holder 1820. The frame 1832 includes bearings 1822 and 1824. Batteries 1834 are used to power the electric motor 1810. Fork 1836 is similar to the fork apparatus as described above for other embodiments. The wheel 1838 is used to turn the vehicle 1800 360° without reversing direction, and the caster wheels 1840 provide stability for the vehicle 1800.

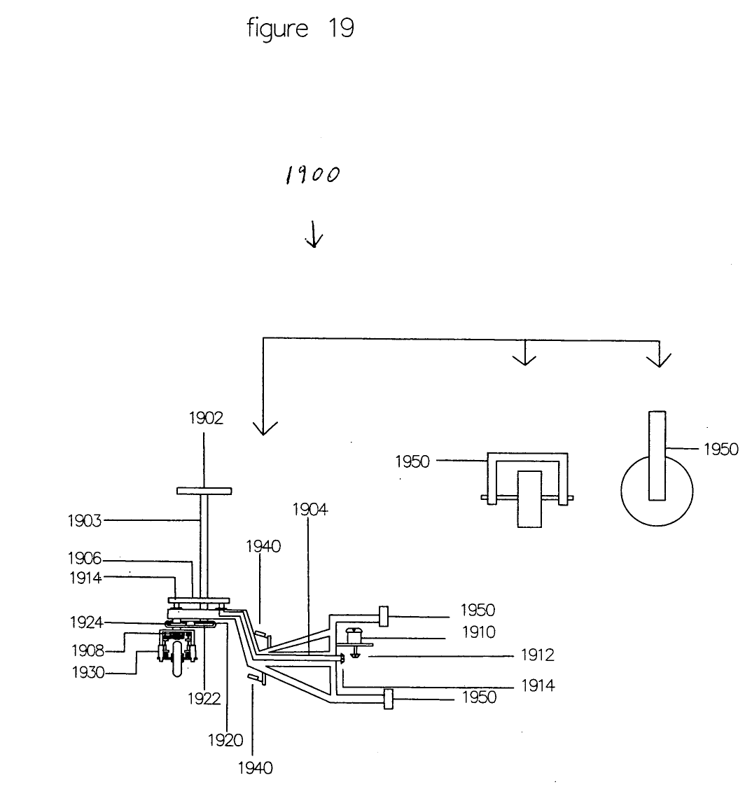

FIG. 19 illustrates another embodiment of the present invention. The vehicle 1900 includes a T-shaped handle 1902. The T-shaped handle 1902 is connected to shaft 1903 and forms a steering wheel to steer the vehicle 1900 360° without reversing direction. Pulley 1920 and pulley 1924 are connected with a belt 1922 to turn the front wheel of the vehicle 1900. The front fork 1930 includes a suspension system with a drive toothed shaft to allow the suspension movement and up and down. The engine 1910 provides the power to move the vehicle 1900, and the engine 1910 is connected to a clutch 1912 to drive the shaft 1914 which can be bent so that the shaft 1914 can follow the frame of the vehicle 1900. The shaft 1914 is connected to a shaft 1911 having pulley 1912 which is connected to belt 1906 which is in turn connected to pulley 1914. FIG. 19 additionally illustrates foot pedals 1940 to steer the rear wheels 1950 90°.

1) A vehicle capable of turning 360°, comprising;
a steering apparatus to steer said vehicle;
a wheel to turn said vehicle and to be responsive to said steering apparatus;
wherein said wheel turns said vehicle 360° without reversing.

2) A vehicle capable of turning 360° as in claim 1 wherein said wheel is powered by an engine of said vehicle.

3) A vehicle capable of turning 360° as in claim 1, wherein said vehicle is a motorcycle.

4) A vehicle capable of turning 360° as in claim 1, wherein said vehicle is a jet plane.

5) A vehicle capable of turning 360° as in claim 1, wherein said vehicle has three wheels.

6) A vehicle capable of turning 360° as in claim 1, wherein said vehicle has four wheels.

7) A vehicle capable of turning 360° as in claim 6, wherein all four wheels are powered by an engine.

8) A vehicle capable of turning 360° as in claim 5, wherein all three wheels are powered by an engine.

9) A vehicle capable of turning 360° as in claim 5, wherein said vehicle has a front wheel and a rear wheel, said front wheel being steered independently of said rear wheel.

10) A method of operating a vehicle capable of turning 3600, comprising the steps of;
steering said vehicle;
turning said vehicle and to be responsive to said steering step;
turning said vehicle 360° without reversing.

11) A method of operating a vehicle capable of turning 360° as in claim 10 wherein said wheel is powered by an engine of said vehicle.

12) A method of operating a vehicle capable of turning 360° as in claim 10, wherein said vehicle is a motorcycle.

13) A method of operating a vehicle capable of turning 360° as in claim 10, wherein said vehicle is a jet plane.

14) A method of operating a vehicle capable of turning 360° as in claim 10, wherein said vehicle has three wheels.

15) A method of operating a vehicle capable of turning 360° as in claim 10, wherein said vehicle has four wheels.

16) A method of operating a vehicle capable of turning 360° as in claim 15, wherein all four wheels are powered by an engine.

17) A method of operating a vehicle capable of turning 360° as in claim 14, wherein all three wheels are powered by an engine.

18) A method of operating a vehicle capable of turning 360° as in claim 14, wherein said vehicle has a front wheel and a rear wheel, said front wheel being steered independently of said rear wheel.
